(19) United States
(12) Patent Application Publication
(10) Pub. No.: US 2010/0140337 A1
(43) Pub. Date: Jun. 10, 2010

(54) CARTON WITH DISPENSING FEATURES

(76) Inventor: Kirsten L. Brand, Marietta, GA (US)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/631,168

(22) Filed: Dec. 4, 2009

Related U.S. Application Data
(60) Provisional application No. 61/201,075, filed on Dec. 4, 2008.

(51) Int. Cl. B65D 17/00; B31B 1/00; B65D 65/28

(52) U.S. Cl. 229/243; 493/52; 428/43

(57) ABSTRACT

A carton for containing a plurality of articles. The carton comprises a plurality of panels that extend at least partially around an interior of the carton. The plurality of panels comprises at least one top panel, a bottom panel, a first side panel, and a second side panel. At least one end flap is foldably attached to at least one panel of the plurality of panels to at least partially close an end of the carton. A dispenser is in the at least one top panel, the dispenser comprising at least one dispenser panel that comprises a plurality of tear-away panels.

### CROSS-REFERENCE TO RELATED APPLICATIONS

This application claims the benefit of Provisional Application No. 61/201,075, filed Dec. 4, 2008, the entire contents of which are hereby incorporated by reference.

### BACKGROUND OF THE DISCLOSURE

The present disclosure generally relates to cartons for holding and dispensing beverage containers or other types of articles. More specifically, the present disclosure relates to cartons having an overlapping first and second dispenser panel.

### SUMMARY OF THE DISCLOSURE

In general, one aspect of the disclosure is directed to a carton for containing a plurality of articles. The carton comprises a plurality of panels that extend at least partially around an interior of the carton. The plurality of panels comprises at least one top panel, a bottom panel, a first side panel, and a second side panel. At least one end flap is foldably attached to at least one panel of the plurality of panels to at least partially close an end of the carton. A dispenser is in the at least one top panel, the dispenser comprising at least one dispenser panel that comprises a plurality of tear-away panels.

In general, one aspect of the disclosure is directed to a blank for forming a carton. The blank comprises a plurality of panels comprising at least one top panel, a bottom panel, a first side panel, and a second side panel, at least one end flap foldably attached to at least one panel of the plurality of panels to at least partially close an end of the carton, and dispenser features for forming a dispenser in the carton formed from the blank. The dispenser features comprise at least one dispenser panel in the at least one top panel. The at least one dispenser panel comprises a plurality of tear-away panels.

In general, one aspect of the disclosure is directed to a method of assembling a carton. The method comprising obtaining a blank comprising a plurality of panels comprising at least one top panel, a bottom panel, a first side panel, and a second side panel. The blank comprises at least one end flap foldably attached to at least one panel of the plurality of panels, and dispenser features for forming a dispenser. The dispenser features of the blank comprise at least one dispenser panel in the at least one top panel, the at least one dispenser panel comprises a plurality of tear-away panels. The method further comprising forming an interior of the carton at least partially defined by the at least one top panel, the bottom panel, the first side panel, and the second side panel. The forming the interior of the carton comprises forming an open-ended sleeve. The method further comprises positioning the at least one end flap to at least partially close an end of the open-ended sleeve.

Those skilled in the art will appreciate the above stated advantages and other advantages and benefits of various additional embodiments reading the following detailed description of the embodiments with reference to the below-listed drawing figures.

According to common practice, the various features of the drawings discussed below are not necessarily drawn to scale. Dimensions of various features and elements in the drawings may be expanded or reduced to more clearly illustrate the embodiments of the disclosure.

### BRIEF DESCRIPTION OF THE DRAWINGS

FIG. 1 is a plan view of a blank used to form a carton according to a first embodiment of the disclosure.

FIG. 2 is a view of the blank of FIG. 1 after a first fold.

FIG. 3 is a view of the blank of FIG. 1 after a second fold with the first and second top panels overlapping.

FIG. 4 is a perspective view of the partially-erected carton formed from the blank of FIG. 1.

FIG. 5 is a perspective view of the erected carton with the first dispenser panel pulled open.

FIG. 6 is a perspective view of the carton with the first dispenser panel removed exposing the second dispenser panel of the carton.

FIG. 7 is a view similar to FIG. 6 with two of the tear-away panels removed.

FIG. 8 is a view similar to FIG. 6 with all of the tear-away panels removed.

Corresponding parts are designated by corresponding reference numbers throughout the drawings.

### DETAILED DESCRIPTION OF THE EXEMPLARY EMBODIMENTS

The present disclosure generally relates to cartons that contain articles such as containers, bottles, cans, etc. The articles can be used for packaging food and beverage products, for example. The articles can be made from materials suitable in composition for packaging the particular food or beverage item, and the materials include, but are not limited to, glass; aluminum and/or other metals; plastics such as PET, LDPE, LLDPE, HDPE, PP, PS, PVC, EVOH, and Nylon; and the like, or any combination thereof.

Cartons according to the present disclosure can accommodate articles of any shape. For the purpose of illustration and not for the purpose of limiting the scope of the disclosure, the following detailed description describes beverage containers (e.g., glass beverage bottles) as disposed within the carton embodiments. In this specification, the terms “lower,” “bottom,” “upper” and “top” indicate orientations determined in relation to fully erected and upright cartons.

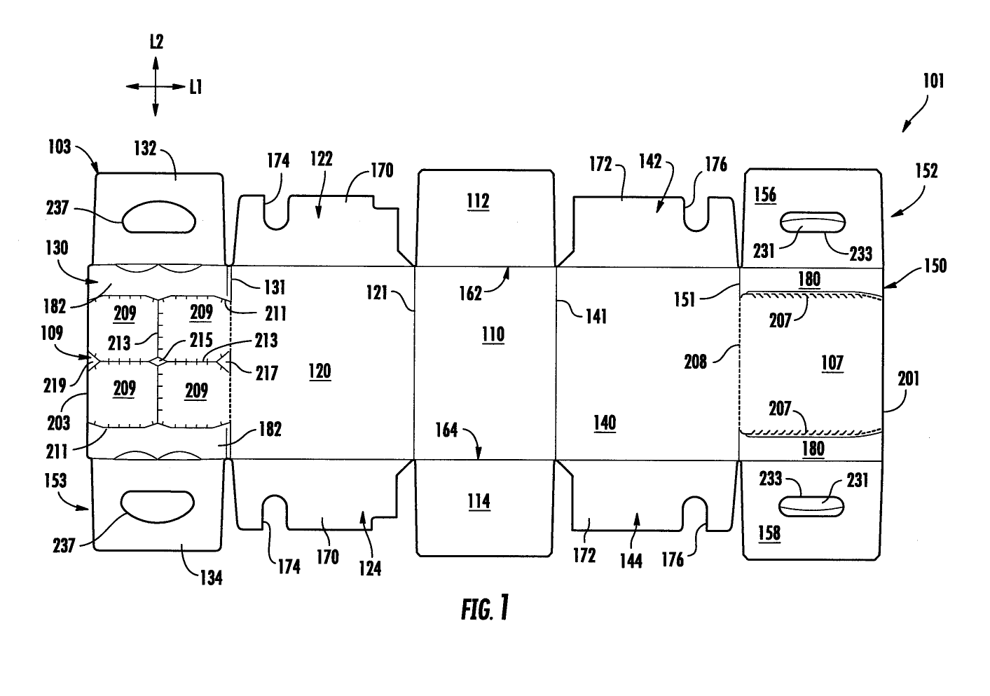

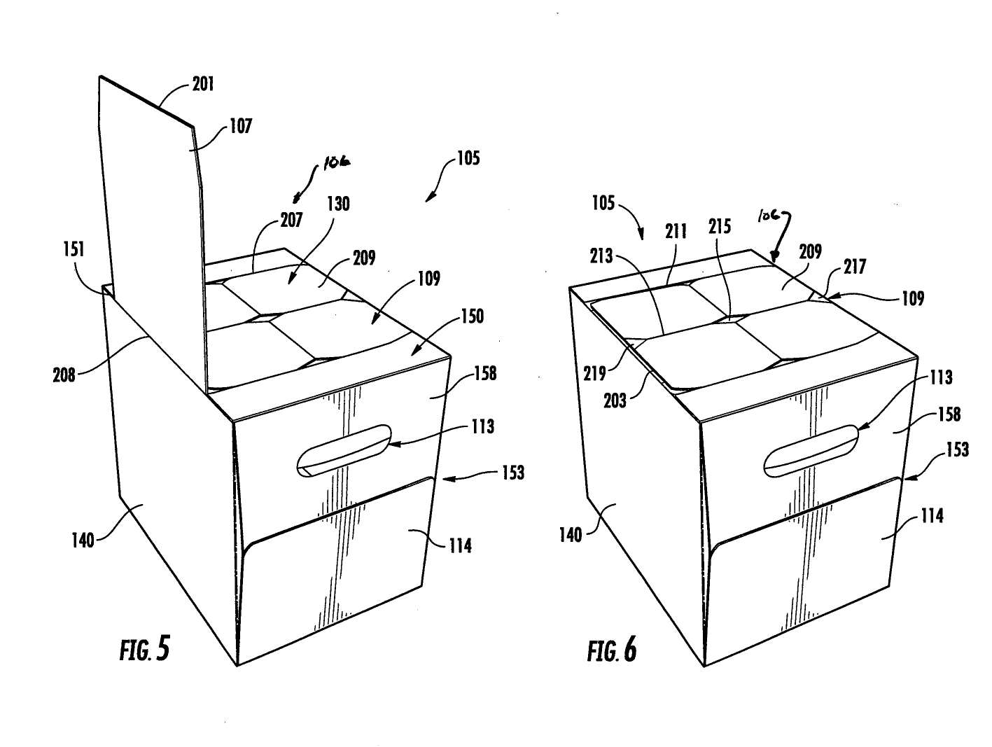

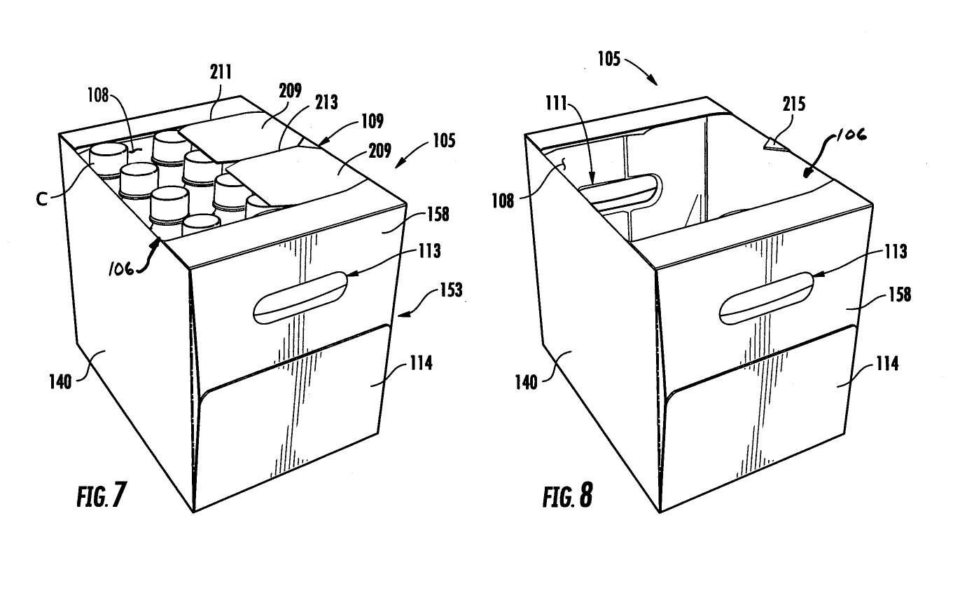

FIG. 1 is a plan view of the interior side 101 of a blank, generally indicated at 103, used to form a carton 105 (FIG. 5) according to the exemplary embodiment of the disclosure. The carton 105 can be used to house a plurality of articles such as containers (not shown). The carton 105 has a dispenser 106 formed from dispensing features in blank 103 that comprises an outer or first dispenser panel, generally indicated at 107 (FIG. 5), and a second dispenser panel, generally indicated at 109, formed in the carton for allowing access to the containers. The first and second dispenser panels 107, 109 are independently positionable to form a dispenser opening 108 (FIGS. 7 and 8) for allowing access to the containers. In the illustrated embodiment, the carton 105 is sized to house twelve containers C in a single layer in a 3×4 arrangement, but the carton 105 may be sized and shaped to hold containers of a different or same quantity in more than one layer and/or in different row/column arrangements (e.g., 1×6, 3×5, 2×6×2, 3×4×2, 2×9, 2×6, 3×6, etc.). In the illustrated embodiment, the carton 105 includes a first and second handle, generally indicated respectively at 111, 113 (FIGS. 7 and 8), for grasping and carrying the carton. As will be discussed below in more detail, the handles 111, 113 are formed from various features in the blank 103.

The blank 103 has a longitudinal axis L1 and a lateral axis L2. In the illustrated embodiment, the blank 103 comprises a bottom panel 110 foldably connected to a first side panel 120 at a first lateral fold line 121, a first top panel 130 foldably connected to the first side panel 120 at a second lateral fold line 131, a second side panel 140 foldably connected to the bottom panel 110 at a third lateral fold line 141, and a second top panel 150 foldably connected to the second side panel 140 at a fourth lateral fold line 151.

The bottom panel 110 is foldably connected to a first bottom end flap 112 and a second bottom end flap 114. The first side panel 120 is foldably connected to a first side end flap 122 and a second side end flap 124. The first top panel 130 is foldably connected to a first top end flap 132 and a second top end flap 134. The second side panel 140 is foldably connected to a first side end flap 142 and a second side end flap 144. The second top panel 150 is foldably connected to a first top end flap 156 and a second top end flap 158.

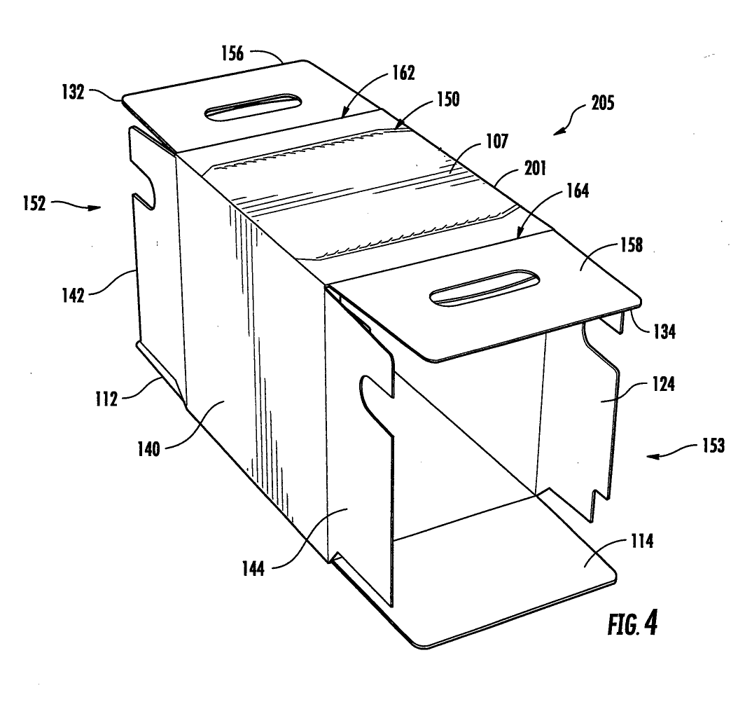

In the illustrated embodiment, the first top and bottom end flaps 132, 156, 112 and first side end flaps 122, 142 extend along a first marginal area of the blank 103, and are foldably connected at a first longitudinal fold line 162 that extends along the length of the blank. The second top and bottom end flaps 134, 158, 114 and second side end flaps 124, 144 extend along a second marginal area of the blank 103, and are foldably connected at a second longitudinal fold line 164 that also extends along the length of the blank. The longitudinal fold lines 162, 164 may be, for example, substantially straight, or offset at one or more locations to account for blank thickness or for other factors. When the carton 105 is erected, the first top and bottom end flaps 132, 156, 112 and first side end flaps 122, 142 close a first end 152 (FIG. 4) of the carton, and the second top and bottom end flaps 134, 158, 114 and second side end flaps 124, 144 close a second end 153 of the carton. In accordance with an alternative embodiment of the present disclosure, different flap arrangements can be used for closing the ends 152, 153 of the carton 105.

In the illustrated embodiment, the first side end flaps 122, 142 each comprise a respective main panel 170, 172 having a cutout 174, 176 formed in an outer edge of the respective end flap. The second side end flaps 124, 144 are similar in shape and construction as the first side end flaps 122, 142, and identical features have been given the same reference numbers for ease of illustration.

The second top panel 150 includes a pair of tear lines, generally indicated 207, that define the first dispenser panel 107. The first dispenser panel 107 is separable from the second top panel 150 at the tear lines 207. In the illustrated embodiment, the first dispenser panel 107 extends the full width (in the longitudinal direction L1) of the second top panel 150, extending from the free edge 201 of the blank 101 to the fold line 151. A user can grasp the first dispenser panel 107 and tear it at least partially away from the rest of the second top panel 150 along tear lines 207. The opposite edge of the first dispenser panel 107 is defined by line of weakening 208 that extends between portions of the fold line 151. The line of weakening 208 can be a fold line, a tear line, a cut line, or any other type of line or area of weakening that allows the first dispenser panel 207 to be folded out or removed from the carton 105. In an alternative embodiment, the first dispenser panel 207 may have a width that is smaller than the longitudinal width of the second top panel 150. In this case, the line of weakening 208 might not coincide with the lateral fold line 151. Further, the leading edge of the first dispenser panel 107 can be spaced from the free edge 201 of the second top panel 150, and the leading edge of the first dispenser panel 107 can be defined by a cut line or a tear line in the blank 103. Also, an optional access aperture or finger panel (not shown) can be provided to allow a user to grasp the first dispenser panel 107 and at least partially separate it from the blank 103. The first dispenser panel 107 may have printed material on one or both of the inner and outer faces. In the illustrated embodiment, the second top panel 150 includes marginal areas 180 between a respective tear line 207 and one of the longitudinal fold lines 162, 164.

In the illustrated embodiment, the first top panel 130 includes the second dispenser panel 109. In one embodiment, the second dispenser panel comprises four tear-away panels 209, which are connected to the rest of the first top panel 130 by peripheral tear lines 211. In the illustrated embodiment, the tear lines 211 extend generally in the longitudinal direction L1 and extend across the width of the first top panel 130 from the lateral fold line 131 to a free edge 203 of the blank 103. The tear lines 211 also extend collinearly with a portion of the fold line 131 in the illustrated embodiment. The tear-away panels 209 are connected together by tear lines 213 and form columns extending in the longitudinal direction L1 and rows extending in the lateral direction L2. In the illustrated embodiment, the tear lines 213 form a generally cross-shaped configuration with one of the tear lines extending generally in the longitudinal direction L1, and the other of the tear lines extending in the lateral direction L2. The second dispenser panel 109 includes a first finger panel 215 at the middle of the second dispenser panel 109 at the junction of the two tear lines 213. The second dispenser panel 109 further includes a second finger panel 217 adjacent to a portion of the fold line 131 and a third finger panel 219 adjacent to the free edge 203 of the blank 103. In the illustrated embodiment, the first top panel 130 includes marginal areas 182 between a respective tear line 211 and one of the longitudinal fold lines 162, 164.

Each of the tear-away panels 209 can be removed from the first top panel 130 by grasping a respective finger panel 215, 217, 219 and tearing the tear-away panel 209 along a corresponding portion of the tear lines 211, 213. In this way, each of the tear-away panels 209 may be removed individually, as desired, to expose the top portion of the containers in the carton 105 and allow removal of the containers from the carton. The second dispenser panel 109 could be otherwise shaped, arranged, and/or configured and could have less than four tear-away panels 209 or more than four tear-away panels. Further, the tear-away panels 209 may be arranged in a different number of rows or columns. In certain embodiments with more than two columns, for example, the tear-away panels in the peripheral columns may be connected to the respective marginal area of the first top panel 130 by the peripheral tear lines 211 while the inner tear-away panels may be connected along tear lines 213. Similarly, embodiments with more than two rows may have peripheral rows and inner rows.

One or both sides of the first dispenser panel 107 and the tear-away panels 209 may include graphics, text, or both printed thereon. While the first dispenser panel 107 typically covers the tear-away panels 209, folding or removing the first dispenser panel 107 can expose graphics or text printed on the tear-away panels. Further, the tear-away panels 209 may be configured to act as coasters or another secondary function after removal from the first top panel 130. The first dispenser panel 107 and the second dispenser panel 109 may be otherwise sized, shaped, and/or located in the carton 105 without departing from the scope of this disclosure.

As shown in FIG. 1, the features that form the first handle 111 of the carton 105 include an elongate handle flap 231 formed in the first top end flap 156 and foldably attached thereto at fold line 233. The first top end flap 132 defines a handle aperture 237 that is large enough to accommodate the handle flap 231 and can be oriented such that the top edge of the aperture 237 approximately lines up with the fold line 233.

The features of the first handle 111 further include respective curved cutouts 174, 176 in the end flaps 122, 142 to allow the handle flap 231 to fold inwardly when the handle is activated to form a handle opening in the carton. The elongate handle flap 231 is shaped and positioned in the blank 103 so that the handle 111 is activated by pressing on the handle flap and folding the handle flap inward into the curved cutouts 174, 176 to form the handle opening in the carton 105. The opening is shaped for insertion of a user's fingers during grasping of the carton 105. The first handle 111 may be otherwise shaped and located in the carton 105 and may include other features not shown or described herein without departing from the scope of this disclosure.

The second handle 113 has features identical to the first handle 111 so that the second handle may be grasped for lifting the carton at the second end 153. The features of the second handle have been given the same reference numbers as noted above for the features of the first handle. The second handle 113 could have features that vary from the features of the first handle, or the second handle can be omitted, without departing from the scope of this disclosure.

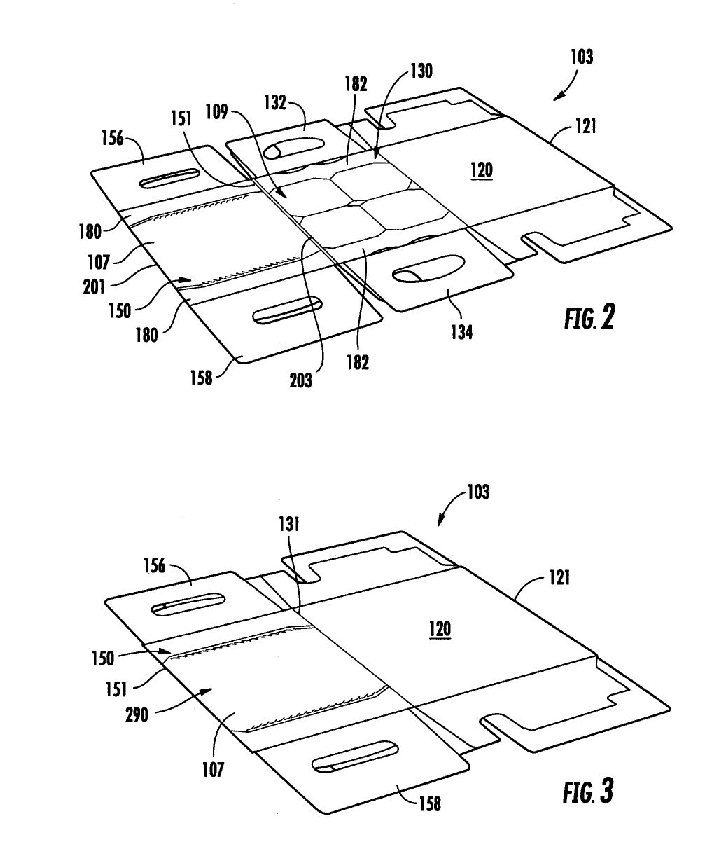

In accordance with the exemplary embodiment, the blank 103 can be erected into the carton 105 by folding along fold line 121 (FIG. 2) to position the first top panel 130 in face-to-face contact with the second side panel 140. The edge 203 of the blank 103 corresponding to the edge of the first top panel 130 is placed in an adjacent or overlapping relationship with the lateral fold line 151. As shown in FIG. 3, the second top panel 150 and the first and second top end flaps 156, 158 are folded at fold line 151 to cover the respective first top end flap 130 and the first and second top end flaps 132, 134. However, the top panels 130, 150 and end flaps 156, 158, 132, 134 may have different degrees of overlap without departing from the scope of the disclosure. The inner face of the marginal areas 180 of the second top panel 150 are overlapped and adhered to the marginal areas 182 of the first top panel 130. The inner faces of the first and second top end flaps 156, 158 may be adhered to the outer faces of the respective first and second top end flaps 132, 134. The adhesive connection of the marginal areas 180, 182 allows the carton 105 to be further erected into the generally open-ended sleeve 205 shown in FIG. 4 by folding along the transverse fold lines 121, 131, 141, 151. The first and second top panels 130, 150 are adhesively secured at the respective marginal areas 180, 182 and the first dispenser panel 107 and second dispenser panel 109 are free from adhesive connection and now form a dispenser 106.

Containers may be loaded into the open-ended sleeve 205 shown in FIG. 4, and the first side end flaps 122, 142, the first bottom end flap 112, and the first top end flaps 132, 156 are folded along the longitudinal fold line 162 and adhered together to close the first end 152. Similarly, the second side end flaps 124, 144, the second bottom end flap 114, and the second top end flaps 134, 158 are folded along the longitudinal fold line 164 and adhered together to close the second end 153. Alternatively one of the ends 152, 153 can be closed prior to loading the containers.

The first handle 111 may be used to grasp the carton 105 by pressing against the elongate handle flap 231 to create a handle opening in the closed end 152 of the carton 105. The handle 111 is shaped and positioned in the carton so that multiple fingers of a user may be placed through the handle opening in the overlapped first top end panels 122, 156 and first side end panels 122, 142. The thumb of a user may be placed on the top panel 150 for grasping and lifting the carton 105. The second handle 113 having the same features as the first handle 111 may be formed in the second end 153 of the carton in a similar manner as the first handle.

Alternative folding and loading sequences to that described above may be used to erect carton 105 without departing from the scope of the application. Further, the blank 103 can be otherwise configured to have multiple bottom panels, multiple side panels, or both without departing from the scope of this disclosure. Even further, the carton 105 may be a wrap-around type carton, with the blank 103 including locking features that can include primary and secondary locking features as is known in the art.

A user may open the carton 105 by grasping the free edge 201 of the first dispenser panel 107 and upwardly folding the flap about line of weakening 208. The first dispenser panel 107 can be separated from the second top panel 150 by tearing away along tear lines 207, as shown in FIG. 5. This reveals the tear-away panels 209 of the second dispenser panel 109. The user may tear off the first dispenser panel 107 by tearing along the line of weakening 208, as shown in FIG. 6, or, alternatively, the user may leave the flap attached, but folded away from the second dispenser panel 109. Further, the first dispenser panel 107 can be folded down at the line of weakening 208 so that the first dispenser panel is adjacent to, or in face-to-face relationship with, the second side panel 140. The user may then access the containers inside the carton 105 by removing the individual tear-away panels 209 as needed by tearing the panels along tear lines 211 and 213. The carton 105 is shown with two tear-away panels removed in FIG. 7 to expose containers C, and all the panels removed in FIG. 8. In one embodiment, the tear-away panels 209 can then be used as coaster as desired.

In the illustrated embodiment, the dispenser features in the blank 103 that form the dispenser 106 of the carton comprise the first dispenser panel 107, second dispenser panel 109, tear lines 207, fold line 208, tear-away panels 211, tear lines 211, 213, and finger panels 215, 217, 219. It is under stood that the dispenser 106 could be formed by other features that are not shown or described herein and that the dispenser 106 could be formed by less than all of the features shown and described herein.

The blank according to the present disclosure can be, for example, formed from coated paperboard and similar materials. For example, the interior and/or exterior sides of the blank can be coated with a clay coating. The clay coating may then be printed over with product, advertising, price coding, and other information or images. The blank may then be coated with a varnish to protect any information printed on the blank. The blank may also be coated with, for example, a moisture barrier layer, on either or both sides of the blank. In accordance with the above-described embodiments, the blank may be constructed of paperboard of a caliper such that it is heavier and more rigid than ordinary paper. The blank can also be constructed of other materials, such as cardboard, hard paper, or any other material having properties suitable for enabling the carton to function at least generally as described herein. The blank can also be laminated or coated with one or more sheet-like materials at selected panels or panel sections.

In accordance with the above-described embodiments of the present disclosure, a fold line can be any substantially linear, although not necessarily straight, form of weakening that facilitates folding therealong. More specifically, but not for the purpose of narrowing the scope of the present disclosure, fold lines may include: a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; and various combinations of these features.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

The above embodiments may be described as having one or more panels adhered together by glue during erection of the carton embodiments. The term “glue” is intended to encompass all manner of adhesives commonly used to secure carton panels in place.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A carton for containing a plurality of articles, the carton comprising:
a plurality of panels that extend at least partially around an interior of the carton, the plurality of panels comprising at least one top panel, a bottom panel, a first side panel, and a second side panel;
at least one end flap foldably attached to at least one panel of the plurality of panels to at least partially close an end of the carton;
a dispenser in the at least one top panel, the dispenser comprising at least one dispenser panel that comprises a plurality of tear-away panels.

2. The carton of claim 1, the at least one top panel comprising a first top panel and a second top panel, wherein the plurality of tear-away panels are in the second top panel.

3. The carton of claim 2, the first top panel is at least partially overlapping the second top panel, the at least one dispenser panel comprising an outer dispenser panel in the first top panel.

4. The carton of claim 3, the outer dispenser panel is at least partially overlapping the plurality of tear-away panels, wherein the outer dispenser panel is independently moveable with respect to the plurality of tear-away panels.

5. The carton of claim 3, the first top panel being foldably connected to the first side panel at a lateral fold line and comprising a lateral free edge opposite to the lateral fold line, the outer dispenser panel comprising at least two tear lines extending longitudinally from the lateral free edge to the lateral fold line.

6. The carton of claim 5, the plurality of tear-away panels comprising at least two tear lines in the second top panel generally coinciding with the respective outer dispenser panel tear lines.

7. The carton of claim 2, the first top panel comprising at least one first marginal area and the second top panel comprising at least one second marginal area, wherein the at least one first marginal area is adhered to the at least one second marginal area.

8. The carton of claim 1 wherein the at least one top panel comprises a first top panel and a second top panel, the at least one dispenser panel comprises a first dispenser panel in the second top panel and a second dispenser panel in the first top panel, the first dispenser panel at least partially overlaps the second dispenser panel, the first dispenser panel being independently movable with respect to the second dispenser panel.

9. The carton of claim 1, wherein the tear-away panels are arranged in at least two rows and at least two columns, wherein each tear-away panel of the plurality of tear-away panels is connected to another tear-away panel in an adjacent row or column by a tear-away panel tear line.

10. The carton of claim 9, the at least two columns of tear-away panels comprising a peripheral column wherein each tear-away panel in the peripheral column is connected to the at least one second top panel by a peripheral tear line.

11. The carton of claim 9, the at least two rows of tear-away panels comprising a first peripheral row and a second peripheral row, wherein the each tear-away panel in the first peripheral row comprises a free edge and each tear-away panel in the second peripheral row is connected to the second side panel by a peripheral tear line that is collinear with a lateral fold line connecting the second top panel to the second side panel.

12. The carton of claim 9, wherein each tear-away panel tear line extends from at least one finger panel.

13. The carton of claim 12, wherein the at least one finger panel comprises a first finger panel that abuts four tear-away panels of the plurality of tear-away panels and a second finger panel that abuts two tear-away panels of the plurality of tear-away panels, the second finger panel comprising a free edge.

14. The carton of claim 1, wherein each tear-away panel of the plurality of tear-away panels is individually separable from the second dispenser panel.

15. The carton of claim 1, the at least one end flap comprising a first end flap and a second end flap, wherein handle features in the first and second end flaps cooperate to form a handle in the closed end of the carton.

16. A blank for forming a carton, the blank comprising:
a plurality of panels comprising at least one top panel, a bottom panel, a first side panel, and a second side panel;
at least one end flap foldably attached to at least one panel of the plurality of panels to at least partially close an end of the carton;
dispenser features for forming a dispenser in the carton formed from the blank, the dispenser features comprise at least one dispenser panel in the at least one top panel, the at least one dispenser panel comprises a plurality of tear-away panels.

17. The blank of claim 16, wherein the at least one top panel comprising a first top panel and a second top panel, and the plurality of tear-away panels are in the second top panel.

18. The blank of claim 17, the first top panel is for at least partially overlapping the second top panel, the at least one dispenser panel comprising an outer dispenser panel in the first top panel.

19. The blank of claim 18, the outer dispenser panel is for at least partially overlapping the plurality of tear-away panels, wherein the outer dispenser panel is independently moveable with respect to the plurality of tear-away panels.

20. The blank of claim 18, the first top panel being foldably connected to the first side panel at a lateral fold line and comprising a lateral free edge opposite to the lateral fold line, the outer dispenser panel comprising at least two tear lines extending longitudinally from the lateral free edge to the lateral fold line.

21. The blank of claim 20, the plurality of tear-away panels comprising at least two tear lines in the second top panel generally coinciding with the respective outer dispenser panel tear lines.

22. The blank of claim 17, the first top panel comprising at least one first marginal area and the second top panel comprising at least one second marginal area, wherein the at least one first marginal area is adhered to the at least one second marginal area when the blank is assembled into the carton.

23. The blank of claim 16 wherein the at least one top panel comprises a first top panel and a second top panel, the at least one dispenser panel comprises a first dispenser panel in the second top panel and a second dispenser panel in the first top panel, the first dispenser panel at least partially overlaps the second dispenser panel when the blank is assembled into the carton, the first dispenser panel being independently movable with respect to the second dispenser panel.

24. The blank of claim 16, wherein the tear-away panels are arranged in at least two rows and at least two columns, wherein each tear-away panel of the plurality of tear-away panels is connected to another tear-away panel in an adjacent row or column by a tear-away panel tear line.

25. The blank of claim 24, the at least two columns of tear-away panels comprising a peripheral column wherein each tear-away panel in the peripheral column is connected to the at least one second top panel by a peripheral tear line.

26. The blank of claim 24, the at least two rows of tear-away panels comprising a first peripheral row and a second peripheral row, wherein the each tear-away panel in the first peripheral row comprises a free edge and each tear-away panel in the second peripheral row is connected to the second side panel by a peripheral tear line that is collinear with a lateral fold line connecting the second top panel to the second side panel.

27. The blank of claim 24, wherein each tear-away panel tear line extends from at least one finger panel.

28. The blank of claim 27, wherein the at least one finger panel comprises a first finger panel that abuts four tear-away panels of the plurality of tear-away panels and a second finger panel that abuts two tear-away panels of the plurality of tear-away panels, the second finger panel comprising a free edge.

29. The blank of claim 16, wherein each tear-away panel of the plurality of tear-away panels is individually separable from the second dispenser panel.

30. The blank of claim 16, the at least one end flap comprising a first end flap and a second end flap, wherein handle features in the first and second end flaps cooperate to form a handle in the closed end of the carton.

31. A method of assembling a carton comprising:
obtaining a blank comprising a plurality of panels comprising at least one top panel, a bottom panel, a first side panel, and a second side panel, at least one end flap foldably attached to at least one panel of the plurality of panels, and dispenser features for forming a dispenser, the dispenser features comprises at least one dispenser panel in the at least one top panel, the at least one dispenser panel comprises a plurality of tear-away panels;
forming an interior of the carton at least partially defined by the at least one top panel, the bottom panel, the first side panel, and the second side panel, the forming the interior of the carton comprises forming an open-ended sleeve; and
positioning the at least one end flap to at least partially close an end of the open-ended sleeve.

32. The method of claim 31, wherein the at least one top panel comprising a first top panel and a second top panel, and the plurality of tear-away panels are in the second top panel, the forming the interior of the carton comprises at least partially overlapping the second top panel with the first top panel, the at least one dispenser panel comprising an outer dispenser panel in the first top panel.

33. The method of claim 32, wherein the outer dispenser panel is at least partially overlapping the plurality of tear-away panels, and the outer dispenser panel is independently moveable with respect to the plurality of tear-away panels.

34. The method of claim 32, the first top panel being foldably connected to the first side panel at a lateral fold line and comprising a lateral free edge opposite to the lateral fold line, the outer dispenser panel being at least partially defined by at least two tear lines extending longitudinally from the lateral free edge to the lateral fold line, the method further comprises pivoting the outer dispenser panel about the lateral fold line and tearing the outer dispenser panel at the at least two tear lines to position the outer dispenser panel in a raised position relative to the inner dispenser panel.

35. The method of claim 34, the plurality of tear-away panels comprising at least two tear lines in the second top panel generally coinciding with the respective outer dispenser panel tear lines.

36. The method of claim 32, wherein the first top panel comprising at least one first marginal area and the second top panel comprising at least one second marginal area, wherein the forming the interior of the carton comprises adhering the at least one first marginal area to the at least one second marginal area.

37. The method of claim 31 wherein the at least one top panel comprises a first top panel and a second top panel, the at least one dispenser panel comprises a first dispenser panel in the second top panel and a second dispenser panel in the first top panel, the forming the interior of the carton comprises at least partially overlapping the first dispenser panel and the second dispenser panel, the first dispenser panel being independently movable with respect to the second dispenser panel.

38. The method of claim 31, wherein the tear-away panels are arranged in at least two rows and at least two columns, wherein each tear-away panel of the plurality of tear-away panels is connected to another tear-away panel in an adjacent row or column by a tear-away panel tear line, the method further comprises separating at least one of the tear-away panels form the second dispenser panel.

39. The method of claim 31, wherein the at least one end flap comprising a first end flap and a second end flap, and the blank comprises handle features in the first and second end flaps, the method further comprising forming a handle from the handle features in the closed end.
